(19) United States
(12) Patent Application Publication
(10) Pub. No.: US 2023/0370278 A1
(43) Pub. Date: Nov. 16, 2023

(54) VEHICLE NETWORK HASHING

(71) Applicant: Ford Global Technologies, LLC, Dearborn, MI (US)

(72) Inventor: Andrew Kamal, Washington Township, MI (US)

(73) Assignee: Ford Global Technologies, LLC, Dearborn, MI (US)

(21) Appl. No.: 17/744,790

(22) Filed: May 16, 2022

(51) Int. Cl. H04L 9/32; H04L 12/40

(52) U.S. Cl. CPC H04L 9/3242; H04L 12/40; H04L 2012/40215

(57) ABSTRACT

A vehicle system includes a vehicle network and a core electronic control unit communicatively coupled to the vehicle network. The core electronic control unit is programmed to generate an initial hash based on a first event on the vehicle network, the initial hash designated as a current hash; and recursively generate a next hash based on a time associated with a next event on the vehicle network and based on the current hash. The next event occurs after the first event. The next hash is designated as the current hash for a next recursion of generating the next hash.

### BACKGROUND

Modern vehicles typically include several electronic control units (ECUs) that communicate with each other by sending messages through a Controller Area Network (CAN) bus. The messages can follow a format such as database CAN (DBC). DBC files typically include designated bits for identifying the message, interpreting the payload, and carrying the payload.

### BRIEF DESCRIPTION OF THE DRAWINGS

FIG. 1 is a block diagram of an example vehicle.

FIG. 2 is a diagram of an example message format used by electronic control units on board the vehicle.

FIG. 3 is a diagram of encryption key storage by the electronic control units.

FIG. 4 is a diagram of a hashing structure used by the electronic control units.

FIG. 5 is a sequence diagram of communication between the electronic control units.

FIG. 6 is a process flow diagram of an example process for a core electronic control unit of the electronic control units to communicate with a secondary electronic control unit of the electronic control units.

FIG. 7 is a process flow diagram of an example process for the secondary electronic control unit to communicate with the core electronic control unit.

### DETAILED DESCRIPTION

This disclosure provides techniques for enhanced digital communications over a vehicle network on board a vehicle. The communications include messages exchanged between electronic control units connected to the vehicle network. Enhanced security for the messages can be provided by hashing, which may be in addition to other security features. Vulnerabilities of hashing may include reverse-hashing attacks and man-in-the-middle attacks, which both rely on computational brute-force methods to undo the operations performed by a hashing algorithm. The techniques herein may reduce these vulnerabilities. The techniques include recursively generating a next hash based on a time associated with an event on the vehicle network and based on a current hash. The next hash becomes designated as the current hash for subsequent recursions of generating the next hash. Recursively generating new hashes can make the previous hashes obsolete, so a hash may become obsolete before a bad actor is able to use a brute-force computation to uncover that hash. Basing the next hash on a time associated with an event on the vehicle network introduces an element of uncertainty into the generation of the next hash each recursion. This uncertainty may prevent reconstruction of the current hash from an uncovered previous hash because the bad actor is not aware of the times of the events for each recursion between the uncovered previous hash and the current hash. Reconstruction of the current hash may be made more difficult by basing the hash generation on the times rather than on programming steps because the bad actor may be able to reproduce the programming steps, while the times may change for different executions of the same programming steps.

A vehicle system includes a vehicle network and a core electronic control unit communicatively coupled to the vehicle network. The core electronic control unit is programmed to generate an initial hash in response to a first event on the vehicle network, the initial hash designated as a current hash; and recursively generate a next hash based on a time associated with a next event on the vehicle network and based on the current hash. The next event occurs after the first event. The next hash is designated as the current hash for a next recursion of generating the next hash.

The vehicle system may further include a secondary electronic control unit communicatively coupled to the vehicle network, and the next event may be a transmission of a message over the vehicle network between the core electronic control unit and the secondary electronic control unit. The secondary electronic control unit may be programmed to receive a second initial hash from the core electronic control unit and recursively generate a second next hash based on the time associated with the next event and based on a second current hash, and the second next hash may be designated as the second current hash for a next recursion of generating the second next hash. The programming of the second electronic control unit to recursively generate the second next hash may include programming to recursively generate the second next hash in response to an indication of the next event. The second electronic control unit may be further programmed to refrain from recursively generating the second next hash until the indication of the next event.

A computer includes a processor and a memory, and the memory stores instructions executable by the processor to generate an initial hash in response to a first event on a vehicle network, the initial hash designated as a current hash; and recursively generate a next hash based on a time associated with a next event on the vehicle network and based on the current hash. The next event occurs after the first event. The next hash is designated as the current hash for a next recursion of generating the next hash.

The time may be based on a time elapsed for the next event. The time may be a time dilation of the time elapsed for the next event.

The instructions to recursively generate the next hash may include instructions to execute a hash algorithm for the time associated with the next event.

The instructions to recursively generate the next hash may include instructions to execute a hash algorithm on the current hash.

The next event may be a transmission of a message over the vehicle network between the computer and an electronic control unit. The time may be based on a time elapsed authenticating the message by the electronic control unit.

The initial hash may be generated from an authentication key, and the instructions may further include instructions to apply a security feature to the message using the current hash.

The instructions may further include instructions to recursively generate a second next hash based on a time associated with a second next event on the vehicle network and based on a second current hash, the second next hash may be designated as the second current hash for a next recursion of generating the second next hash, the second next event may be a second transmission of a second message over the vehicle network between the computer and a second electronic control unit, and the second transmission may overlap the transmission of the message. The current hash may be designated as the second current hash for an initial recursion of generating the second next hash.

The next event may be a transmission of a message over the vehicle network between the computer and any of a plurality of electronic control units.

The initial hash may be generated from an authentication key.

The instructions to recursively generate the next hash may include instructions to recursively generate the next hash in response to an indication of the next event. The instructions may further include instructions to refrain from recursively generating the next hash until the indication of the next event.

A method includes generating an initial hash in response to a first event on a vehicle network, the initial hash designated as a current hash; and recursively generating a next hash based on a time associated with a next event on the vehicle network and based on the current hash. The next event occurs after the first event. The next hash is designated as the current hash for a next recursion of generating the next hash.

With reference to the Figures, wherein like numerals indicate like parts throughout the several views, a vehicle system 105 of a vehicle 100 includes a vehicle network 110 and a core electronic control unit (ECU) 115 communicatively coupled to the vehicle network 110. The core ECU 115 is programmed to generate an initial hash 405 based on a first event on the vehicle network 110, the initial hash 405 designated as a current hash; and recursively generate a next hash 410 based on a time associated with a next event on the vehicle network 110 and based on the current hash. The next event occurs after the first event. The next hash 410 is designated as the current hash for a next recursion of generating the next hash 410.

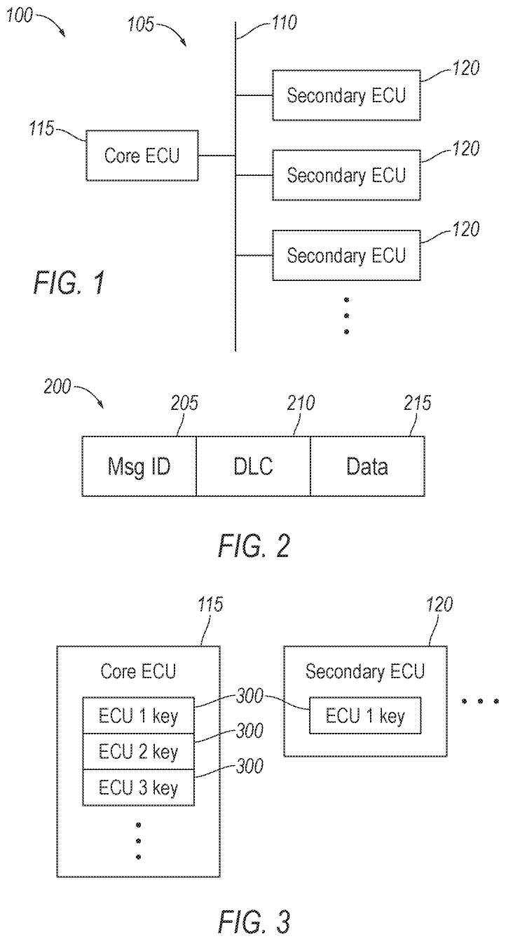

With reference to FIG. 1, the vehicle 100 may be any passenger or commercial automobile such as a car, a truck, a sport utility vehicle, a crossover, a van, a minivan, a taxi, a bus, etc.

The vehicle 100 includes the vehicle network 110. The vehicle network 110 is a communications network, e.g., a wired communications network, on board the vehicle 100. The vehicle network 110 can be any standard network protocol for vehicles 100 such as controller area network (CAN) bus, Ethernet, Local Interconnect Network (LIN), onboard diagnostics connector (OBD-II), any other type of wired network, or a combination of different types of wired networks. The core ECU 115 and a plurality of secondary ECUs 120 are communicatively coupled to the vehicle network 110, and the vehicle network 110 communicatively couples the ECUs 115, 120 together. If the vehicle network 110 is a CAN bus, the vehicle network 110 can use multiplex electrical wiring to interconnect the ECUs 115, 120. The vehicle network 110 can be divided into subnetworks connected together, e.g., by a gateway module (not shown).

The core ECU 115 and secondary ECUs 120 are microprocessor-based computing devices, e.g., generic computing devices including a processor and a memory, an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. Each ECU 115, 120 can thus include a processor, a memory, etc. The memory of each ECU 115, 120 can include media for storing instructions executable by the processor as well as for electronically storing data and/or databases, and/or the ECU 115, 120 can include structures such as the foregoing by which programming is provided.

The ECUs 115, 120 can be programmed for performing different functions for the vehicle 100. For example, the ECUs 115, 120 can include an engine control module, a body control module, a restraint control module, an accessory control module, a power-steering control module, an antilock brake control module, etc. The vehicle 100 may contain between fifty and one hundred ECUs 115, 120.

The ECUs 115, 120 can be organized into subnetworks on the vehicle network 110. For example, one core ECU 115 and a plurality of the secondary ECUs 120 can be communicatively coupled on a subnetwork. The core ECU 115 may coordinate activity by the secondary ECUs 120 on the same subnetwork.

With reference to FIG. 2, the ECUs 115, 120 can be programmed to transmit messages 200 to each other. The ECUs 115, 120 construct the message 200 according to a standardized format, e.g., database CAN (DBC). For example, the format can specify an order of information included in a message 200, how many bits are allocated to each piece of information, what information a pattern of bits represents, which ECUs 115, 120 transmit and/or receive a message 200, and so on. For example, the format can include a message identification 205, a data length code 210 after the message identification 205, and data content 215 after the data length code 210. The message identification 205 uniquely specifies the message 200 and can represent a priority of the message 200. The message identification 205 may include a header indicating a destination of the message 200, i.e., the ECU 115, 120 for which the message 200 is intended. The data length code 210 can specify a bit length of the data content 215. The data content 215 contains the informational content of the message 200, i.e., the payload, e.g., engine RPMs from the engine control module, deployment instructions for airbags or pretensioners from the restraint control module, etc.

With reference to FIG. 3, each ECU 115, 120 can be programmed to apply a security feature to a message 200 before transmitting the message 200 over the vehicle network 110. Applying the security feature can include using an authentication key 300. For example, the ECU 115, 120 can generate and append a message authentication code (MAC) and/or encrypt the message 200.

A MAC is a piece of information included in a message 200 to ensure that the transmitting ECU 115, 120 and the receiving ECU 115, 120 both have the same authentication key 300. The transmitting ECU 115, 120 generates the MAC by performing an operation on some portion of the message 200, e.g., the data content 215, and the receiving ECU 115, 120 performs an operation on the MAC to reproduce the authentication key 300 and verify that the reproduced authentication key 300 matches the authentication key 300 stored on the receiving ECU 115, 120.

For encryption, the transmitting ECU 115, 120 and the receiving ECU 115, 120 store corresponding authentication keys 300. The transmitting ECU 115, 120 uses its stored authentication key 300 to encrypt the message 200, and the receiving ECU 115, 120 uses its stored authentication key 300 to decrypt the message 200. The encryption algorithm can be any suitable type, e.g., stream cipher, block cipher, etc. Stream ciphers encrypt characters of a message 200 one by one. Block ciphers encrypt a block of bits while padding the plaintext. An example of block ciphering is the Advanced Encryption Standard algorithm promulgated by the National Institute of Standards and Technology. The encryption scheme can be, e.g., symmetric key, public-private key, etc. In a symmetric key scheme, the transmitting ECU 115, 120 and the receiving ECU 115, 120 store the same authentication key 300, which can be used for both encryption and decryption. In a public-private key scheme, the transmitting ECU 115, 120 stores a private key used for encryption, and the receiving ECU 115, 120 stores a public key for decryption. The private key is not known to the receiving ECU 115, 120. The public key may be made more widely available.

Each ECU 115, 120 can store the authentication keys 300 in memory for its role in the security scheme. For example, one or more of the ECUs 115, 120, such as the core ECU 115, can store a table of the authentication keys 300. The table can have entries for the secondary ECUs 120. In the respective entry for one of the secondary ECUs 120, the table can include a network address of the secondary ECU 120 and an authentication key 300 for the secondary ECU 120, e.g., a symmetric key or a private key. The secondary ECU 120 can store a corresponding authentication key 300, e.g., the symmetric key or a public key corresponding to the private key.

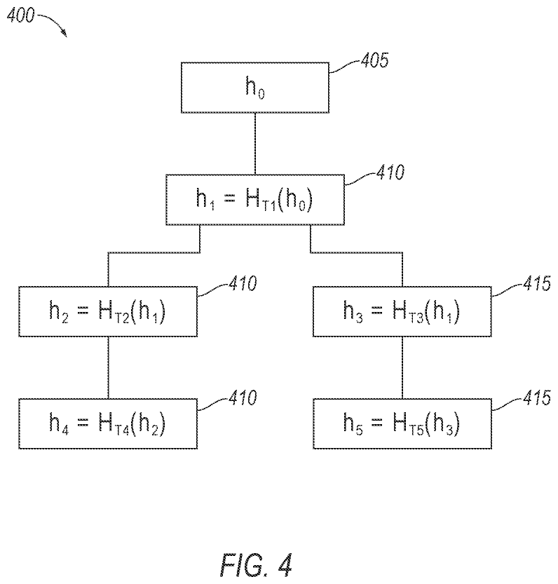

With reference to FIG. 4, the core ECU 115 can be programmed to create an initial hash 405 h₀. For example, the initial hash 405 can be generated from one of the authentication keys 300. The core ECU 115 may initially store a single authentication key 300, and the initial hash 405 h₀ can be generated from that authentication key 300. For example, the core ECU 115 may store a single authentication key 300 when the vehicle 100 is turned on. (The generation of multiple authentication keys 300, as mentioned with respect to FIG. 3, is described further below.)

For example, the core ECU 115 can generate the initial hash 405 h₀ by executing a hash algorithm H on the authentication key 300. The hash algorithm H can be a cryptographic hash function, e.g., a keyed cryptographic hash function such as BLAKE2, BLAKE3, HMAC, KMAC, MD6, one-key MAC, PMAC, Poly1305-AES, SipHash, HighwayHash, UMAC, VMAC, etc., or may be a simpler hash function such as MD5. The recursive generation of the next hashes 410 described below can permit a simpler hash function such as MD5 to be used, or can make a keyed cryptographic hash function more secure, e.g., even against attacks using quantum computing.

The core ECU 115 can be programmed to create the initial hash 405 h₀ in response to a first event on the vehicle network 110. For example, the first event can be the vehicle 100 turning on, i.e., transitioning from an off state to an on state. For the purposes of this disclosure, “on state” is defined as the state of the vehicle 100 in which full electrical energy is provided to electrical components of the vehicle 100 and the vehicle 100 is ready to be driven, e.g., the engine is running; “off state” is defined as the state of the vehicle 100 in which a low amount of electrical energy is provided to selected electrical components of the vehicle 100, typically used when the vehicle 100 is being stored. For another example, the first event can be the first occurrence of some type of event after the vehicle 100 is turned on, e.g., the first transmission of a message 200 over the vehicle network 110 between the core ECU 115 and one of the secondary ECUs 120.

The ECUs 115, 120 can be programmed to recursively generate a next hash 410 hᵢ based on a current hash, in which i is an index of the recursions. For each ECU 115, 120, the current hash hᵢ₋₁ is stored in the memory of that ECU 115, 120. For example, the ECU 115, 120 can generate the next hash 410 hᵢ by executing a hash algorithm on the current hash. The hash algorithm can be a cryptographic hash function, e.g., a keyed cryptographic hash function such as BLAKE2, BLAKE3, HMAC, KMAC, MD6, one-key MAC, PMAC, Poly1305-AES, SipHash, HighwayHash, UMAC, VMAC, etc., or may be a simpler hash function such as MD5. The result of the recursive generation is a hash structure 400 that is a chain of the next hashes 410 hᵢ.

The next hash 410 hᵢ is designated as the current hash hᵢ₋₁ for a next recursion of generating the next hash 410. In other words, once the next hash 410 hᵢ is generated, the index i increments by one, that next hash 410 hᵢ becomes the current hash hᵢ₋₁, and then a new next hash 410 hᵢ is generated based on the current hash hᵢ₋₁, i.e., the immediately previous next hash 410. Before the first recursion, i.e., before the first time that the next hash 410 hᵢ is generated, the initial hash 405 h₀ is designated as the current hash. During the first generation of the next hash 410 hᵢ, i.e., hᵢ, the initial hash 405 h₀ is used as the current hash hᵢ₋₁.

Generating the next hash 410 hᵢ can be performed in response to an indication of a next event. For example, the next event can be a transmission of a message 200 over the vehicle network 110, e.g., between the core ECU 115 and one of the secondary ECUs 120 or between two of the secondary ECUs 120. For the purposes of this disclosure, an “indication” of an event is some evidence that the event has occurred, is occurring, or will imminently occur. For example, indications of the transmission of a message 200 can include generating the message 200, transmitting the message 200, receiving the message 200, authenticating the message 200, etc. All the next events on a given ECU 115, 120 occur after the first event, e.g., on a single trip of the vehicle 100.

The ECUs 115, 120 can be programmed to determine a time Tᵢ associated with the next event. The subscript i represents an index of the number of recursions of generating the next hash 410 hᵢ. The time Tᵢ can be or can be derived from a time elapsed for the next event, e.g., a time elapsed of some phase or step of the next event. For example, if the next event is the transmission of a message 200, the time Tᵢ can be or can be derived from a time elapsed authenticating the message 200 by the receiving ECU 115, 120. Because the time elapsed for the next event, e.g., the time elapsed authenticating the message 200, can vary, using the time Tᵢ when generating the next hash 410 can introduce randomness to each recursion of generating the next hash 410, making reproduction more difficult for a bad actor.

The time Tᵢ can be derived from a time elapsed for the next event. For example, the time Tᵢ can be a time dilation of the time elapsed for the next event, i.e., a local time elapsed within performance of a task, with the time elapsed measured outside the performance of the task. For example, the time Tᵢ can be given by the following equation:

$${T}_{i} = \frac{{T}_{m i}}{\sqrt{1 - \frac{{v}^{2}}{{c}^{2}}}}$$

in which Tₘᵢ is a measured time elapsed, e.g., for authenticating the message 200; v is a velocity associated with the next event; and c is the speed of light in a vacuum. The time elapsed Tₘᵢ can be known from timestamps provided by the ECUs 115, 120. For example, the time elapsed Tₘᵢ can be a difference between an end timestamp and a begin timestamp, e.g., a timestamp upon authenticating the message 200 minus a timestamp from transmitting or receiving the message 200. The velocity v can be known based on the nature of the task performed for the next event, e.g., signals traveling through circuits of the ECUs 115, 120 and/or the vehicle network 110 can travel at a known percentage of the speed of light in a vacuum c.

Generating the next hash 410 hᵢ is based on the time Tᵢ associated with the next event. For example, the time Tᵢ can be an input to the hash algorithm, e.g., an argument for the hash algorithm. For another example, the ECU 115, 120 can execute the hash algorithm for the time Tᵢ, e.g., hᵢ=H_{Ti}(hᵢ₋₁), in which the subscript i is an index of the recursion, h is the hash, H is the hash algorithm, and the subscript Tᵢ is the time over which the hash algorithm executes. For one example of executing the hash algorithm H for the time Tᵢ, the hash algorithm H can be executed a number of iterations such that the total execution time equals the time Tᵢ, e.g., five iterations if the time Tᵢ is 5 milliseconds (ms) and the execution time for one iteration is 1 ms, with the output of the hash algorithm H for each iteration serving as the argument for the hash algorithm in the next iteration, i.e., hᵢ=H_{Ti}(hᵢ₋₁)=H(H(H(H(H(hᵢ₋₁))))). For another example of executing the hash algorithm for the time Tᵢ, the hash algorithm can be length-preserving, i.e., can have an output the same length as the argument and can have intermediate operations that keep the length the same, and the hash algorithm can be interrupted partway through once the hash algorithm has executed for the time Tᵢ. Length can be measured in number of bits.

The ECU 115, 120 can be programmed to, in response to a second next event overlapping the next event, recursively generate a second next hash 415 based on a time associated with the second next event on the vehicle network 110 and based on a second current hash. The current hash is designated as the second current hash for an initial recursion of generating the second next hash 415. In other words, in response to two of the next events occurring simultaneously or near simultaneously, generating the next hash 410 occurs twice based on the current hash, resulting in a branching of the hash structure 400 of next hashes 410. In the example of FIG. 4, the next hash 410 h₂ and the second next hash 415 h₃ are both based on the current hash h₁. Recursion may then occur independently for each branch, e.g., the next hash 410 h₄ based on the current hash h₂ and the second next hash 415 h₅ based on the second current hash h₃. The next hash 410 can be designated as the current hash for a next recursion of generating the next hash 410, and the second next hash 415 can be designated as the second current hash for a next recursion of generating the second next hash 415.

Generating the second next hash 415 can be performed in the same manner as described above for generating the next hash 410, and the same type of event can be used as the next event and the second next event. For example, the next event can be the transmission of the message 200, and the second next event can be a second transmission of a second message 200 over the vehicle network 110 between two of the ECUs 115, 120, with the second transmission overlapping the transmission of the first message 200. Once branching has occurred, the type of event can be subdivided between the next events and the second next events, e.g., the next events can be the transmission of messages 200 between the core ECU 115 and the secondary ECUs 120 other than the receiving secondary ECU 120 of the second message 200, and the second next events can be the transmission of messages 200 between the core ECU 115 and the receiving secondary ECU 120 of the second message 200.

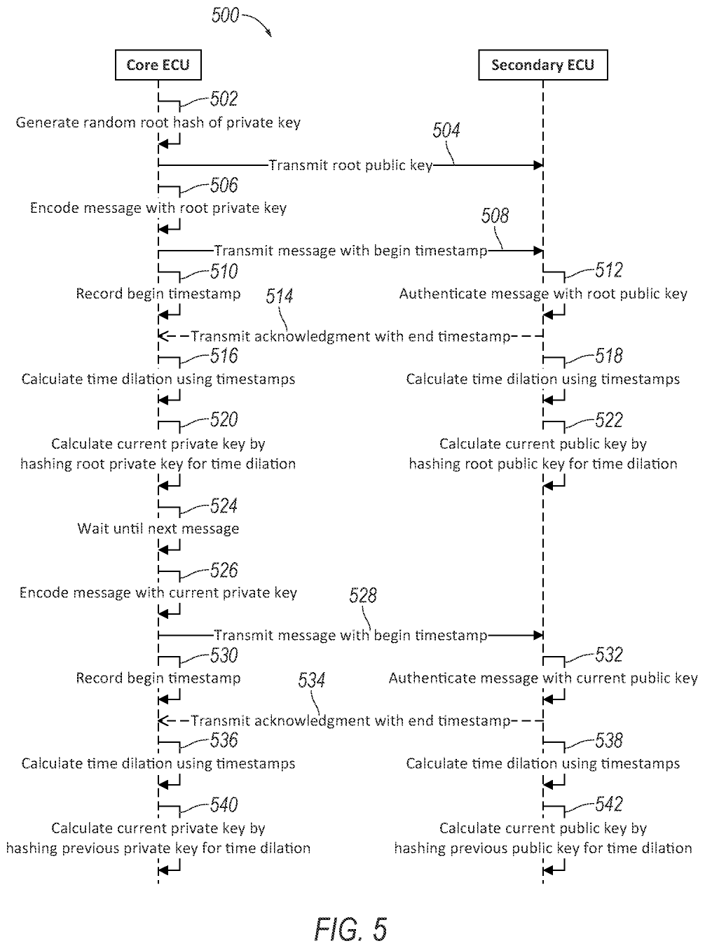

FIG. 5 is a sequence diagram showing an example sequence 500 of steps performed by the core ECU 115 and one of the secondary ECUs 120. The memories of the core ECU 115 and the secondary ECU 120 store executable instructions for performing the steps of the sequence 500 and/or programming can be implemented in structures such as mentioned above. The sequence 500 can begin in response to the first event on the vehicle network 110, as described above.

In a step 502, the core ECU 115 generates the initial hash 405, as described above. In the example of FIG. 5, the core ECU 115 generates the initial hash 405 from an authentication key 300, specifically a private key, for the secondary ECU 120. The initial hash 405 is designated as the current hash.

Next, in a step 504, the core ECU 115 transmits a second initial hash 405 to the secondary ECU 120, and the secondary ECU 120 receives the second initial hash 405. In the example of FIG. 5, the second initial hash 405 is of a public key corresponding to the private key. Applying the same hashing algorithm to the private key and public key can maintain the correspondence in the hash of the private key and the hash of the public key, i.e., a security feature applied using the hash of the private key can be authenticated using the hash of the public key.

Next, in a step 506, the core ECU 115 applies a security feature to a message 200 to be sent to the secondary ECU 120 by using the current hash, i.e., the initial hash 405, as described above. For example, the core ECU 115 calculates and appends a MAC to the message 200 using the current hash.

Next, in a step 508, the core ECU 115 transmits the message 200. The message 200 can include a begin timestamp, e.g., the timestamp at which the message 200 was sent. The core ECU 115 can record the begin timestamp in a step 510.

Upon receiving the message 200, in a step 512, the secondary ECU 120 authenticates the message 200 using the second initial hash 405, as described above.

Next, in a step 514, the secondary ECU 120 transmits an acknowledgment to the core ECU 115. The acknowledgment can include an end timestamp, e.g., the timestamp at which the authentication of step 512 completed. Alternatively to the message 200 including the begin timestamp, the acknowledgment may instead include a begin timestamp, e.g., the timestamp at which the authentication of step 512 began, in addition to the end timestamp.

Next, in a step 516, the core ECU 115 determines the time, e.g., the time dilation, as described above, using the begin timestamp and the end timestamp.

Simultaneously, in a step 518, the secondary ECU 120 determines the time, e.g., the time dilation, as described above, using the begin timestamp and the end timestamp.

Next, in a step 520, the core ECU 115 generates the next hash 410 based on the time determined in the step 516 and based on the current hash, here the initial hash 405 generated in the step 502, as described above. The next hash 410 is then designated as the current hash.

Simultaneously, in a step 522, the secondary ECU 120 generates the second next hash 415 based on the time determined in the step 518 and based on the second current hash, here the second initial hash 405 received in the step 504, as described above. The second next hash 415 is then designated as the second current hash.

Next, in a step 524, the core ECU 115 waits for the next message 200 to be ready to transmit. The core ECU 115 refrains from generating the next hash 410 until the indication of the next event, here the message 200 being ready to transmit. The secondary ECU 120 refrains from generating the second next hash 415 until the indication of the next event, here receiving the message 200.

Next, in response to receiving the indication of the next event, in a step 526, the core ECU 115 applies a security feature to the message 200 to be sent to the secondary ECU 120 by using the current hash, as described above. For example, the core ECU 115 calculates and appends a MAC to the message 200 using the current hash.

Next, in a step 528, the core ECU 115 transmits the message 200. The message 200 can include a begin timestamp, e.g., the timestamp at which the message 200 was sent. The core ECU 115 can record the begin timestamp in a step 530.

Upon receiving the message 200, in a step 532, the secondary ECU 120 authenticates the message 200 using the second current hash, as described above.

Next, in a step 534, the secondary ECU 120 transmits an acknowledgment to the core ECU 115. The acknowledgment can include an end timestamp, e.g., the timestamp at which the authentication of step 532 completed. Alternatively to the message 200 including the begin timestamp, the acknowledgment may instead include a begin timestamp, e.g., the timestamp at which the authentication of step 532 began, in addition to the end timestamp.

Next, in a step 536, the core ECU 115 determines the time, e.g., the time dilation, as described above, using the begin timestamp and the end timestamp.

Simultaneously, in a step 538, the secondary ECU 120 determines the time, e.g., the time dilation, as described above, using the begin timestamp and the end timestamp.

Next, in a step 540, the core ECU 115 generates the next hash 410 based on the time determined in the step 536 and based on the current hash generated in the step 520, as described above. The next hash 410 is then designated as the current hash.

Simultaneously, in a step 542, the secondary ECU 120 generates the second next hash 415 based on the time determined in the step 538 and based on the second current hash generated in the step 522, as described above. The second next hash 415 is then designated as the second current hash.

The steps 524 through 542 can be performed recursively by the core ECU 115 and the secondary ECU 120, with the next hash 410 designated as the current hash and the second next hash 415 designated as the second current hash for the next recursion.

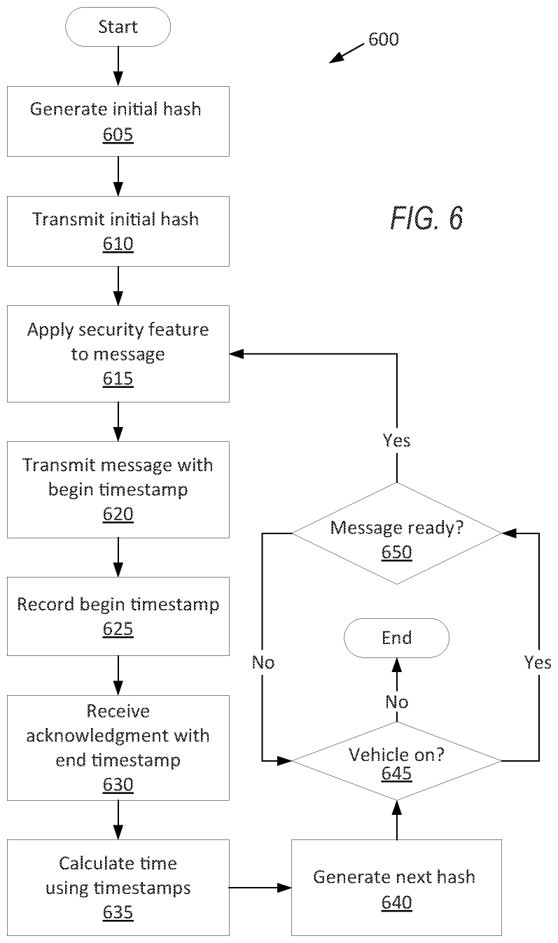

FIG. 6 is a process flow diagram illustrating an example process 600 for the core ECU 115 to communicate with the secondary ECU 120. The memory of the core ECU 115 stores executable instructions for performing the steps of the process 600 and/or programming can be implemented in structures such as mentioned above. As a general overview of the process 600, the core ECU 115 generates the initial hash 405 and transmits the initial hash 405 to the secondary ECU 120. Then, for as long as the vehicle 100 remains on, the core ECU 115 performs a recursion upon a message 200 being ready. Each recursion includes applying a security feature to the message 200, transmitting the message 200 to the secondary ECU 120, recording the begin timestamp, receiving an acknowledgment with an end timestamp, determining the time using the timestamps, and determining the next hash 410.

The process 600 begins in a block 605, in which the core ECU 115 generates the initial hash 405, as described above, which is designated as the current hash.

Next, in a block 610, the core ECU 115 transmits the initial hash 405, as described above.

Next, in a block 615, the core ECU 115 applies the security feature to the message 200 using the current hash, as described above.

Next, in a block 620, the core ECU 115 transmits the message 200 to the secondary ECU 120. The message 200 may include the begin timestamp, as described above.

Next, in a block 625, the core ECU 115 optionally records the begin timestamp, as described above.

Next, in a block 630, the core ECU 115 receives the acknowledgment from the secondary ECU 120. The acknowledgment may include the end timestamp or may include both the begin timestamp and the end timestamp.

Next, in a block 635, the core ECU 115 determines the time associated with the next event using the begin and end timestamps, as described above.

Next, in a block 640, the core ECU 115 generates the next hash 410 based on the time determined in the block 635 and the current hash generated in the previous execution of the block 640 (or, for the first execution of the block 640, in the block 605), as described above.

Next, in a decision block 645, the core ECU 115 determines whether the vehicle 100 is still on, i.e., has not transitioned from the on state to the off state, as described above. If the vehicle 100 is still on, the process 600 proceeds to a decision block 650. If the vehicle 100 has been turned off, the process 600 ends.

In the decision block 650, the core ECU 115 determines whether another message 200 is ready to send. If a message 200 is ready, the process 600 returns to the block 615 to recursively perform the blocks 615 through 640. If a message 200 is not ready, the process 600 returns to the decision block 645 to wait until either the vehicle 100 is turned off or a message 200 is ready.

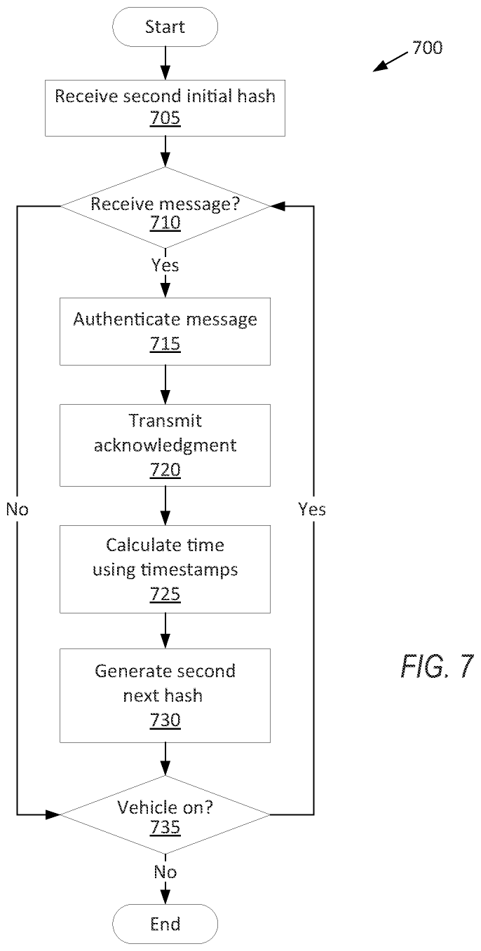

FIG. 7 is a process flow diagram illustrating an example process 700 for the secondary ECU 120 to communicate with the core ECU 115. The memory of the secondary ECU 120 stores executable instructions for performing the steps of the process 700 and/or programming can be implemented in structures such as mentioned above. As a general overview of the process 700, the secondary ECU 120 receives the initial hash 405 from the core ECU 115. In response to each message 200 received from the core ECU 115, the secondary ECU 120 authenticates the message 200, transmits the acknowledgment, determines the time, and generates the second next hash 415. The process 700 continues for as long as the vehicle 100 remains on.

The process 700 begins in a block 705, in which the secondary ECU 120 receives the second initial hash 405 from the core ECU 115, as described above.

Next, in a decision block 710, the secondary ECU 120 determines whether it has received a message 200 from the core ECU 115. Upon receiving a message 200, the process 700 proceeds to a block 715. If a message 200 has not yet been received, the process 700 proceeds to a decision block 735.

In the block 715, the secondary ECU 120 authenticates the message 200, as described above. The message 200 may include the begin timestamp.

Next, in a block 720, the secondary ECU 120 transmits an acknowledgment to the core ECU 115. The acknowledgment may include the end timestamp, or the acknowledgment may include both the begin and end timestamps.

Next, in a block 725, the secondary ECU 120 determines the time associated with the next event using the begin and end timestamps, as described above.

Next, in a block 730, the secondary ECU 120 generates the second next hash 415 based on the time determined in the block 725 and the second current hash generated in the previous execution of the block 730 (or, for the first execution of the block 730, received in the block 705), as described above. After the block 730, the process 700 proceeds to the decision block 735.

In the decision block 735, the secondary ECU 120 determines whether the vehicle 100 is still on, i.e., has not transitioned from the on state to the off state, as described above. If the vehicle 100 is still on, the process 700 returns to the decision block 710 to wait until either the vehicle 100 is turned off or a message 200 is received. If the vehicle 100 has been turned off, the process 700 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship. The adjectives “first” and “second” are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A vehicle system comprising:
a vehicle network; and
a core electronic control unit communicatively coupled to the vehicle network;
wherein the core electronic control unit is programmed to:
generate an initial hash in response to a first event on the vehicle network, the initial hash designated as a current hash; and
recursively generate a next hash based on a time associated with a next event on the vehicle network and based on the current hash, the next event occurring after the first event, the next hash being designated as the current hash for a next recursion of generating the next hash.

2. The vehicle system of claim 1, further comprising a secondary electronic control unit communicatively coupled to the vehicle network, wherein the next event is a transmission of a message over the vehicle network between the core electronic control unit and the secondary electronic control unit.

3. The vehicle system of claim 2, wherein the secondary electronic control unit is programmed to:
receive a second initial hash from the core electronic control unit; and
recursively generate a second next hash based on the time associated with the next event and based on a second current hash, the second next hash being designated as the second current hash for a next recursion of generating the second next hash.

4. The vehicle system of claim 3, wherein the programming of the second electronic control unit to recursively generate the second next hash includes programming to recursively generate the second next hash in response to an indication of the next event.

5. The vehicle system of claim 4, wherein the second electronic control unit is further programmed to refrain from recursively generating the second next hash until the indication of the next event.

6. A computer comprising a processor and a memory, the memory storing instructions executable by the processor to:
generate an initial hash in response to a first event on a vehicle network, the initial hash designated as a current hash; and
recursively generate a next hash based on a time associated with a next event on the vehicle network and based on the current hash, the next event occurring after the first event, the next hash being designated as the current hash for a next recursion of generating the next hash.

7. The computer of claim 6, wherein the time is based on a time elapsed for the next event.

8. The computer of claim 7, wherein the time is a time dilation of the time elapsed for the next event.

9. The computer of claim 6, wherein the instructions to recursively generate the next hash include instructions to execute a hash algorithm for the time associated with the next event.

10. The computer of claim 6, wherein the instructions to recursively generate the next hash include instructions to execute a hash algorithm on the current hash.

11. The computer of claim 6, wherein the next event is a transmission of a message over the vehicle network between the computer and an electronic control unit.

12. The computer of claim 11, wherein the time is based on a time elapsed authenticating the message by the electronic control unit.

13. The computer of claim 11, wherein the initial hash is generated from an authentication key, and the instructions further include instructions to apply a security feature to the message using the current hash.

14. The computer of claim 11, wherein the instructions further include instructions to recursively generate a second next hash based on a time associated with a second next event on the vehicle network and based on a second current hash, the second next hash being designated as the second current hash for a next recursion of generating the second next hash, the second next event being a second transmission of a second message over the vehicle network between the computer and a second electronic control unit, the second transmission overlapping the transmission of the message.

15. The computer of claim 14, wherein the current hash is designated as the second current hash for an initial recursion of generating the second next hash.

16. The computer of claim 6, wherein the next event is a transmission of a message over the vehicle network between the computer and any of a plurality of electronic control units.

17. The computer of claim 6, wherein the initial hash is generated from an authentication key.

18. The computer of claim 6, wherein the instructions to recursively generate the next hash include instructions to recursively generate the next hash in response to an indication of the next event.

19. The computer of claim 18, wherein the instructions further include instructions to refrain from recursively generating the next hash until the indication of the next event.

20. A method comprising:
generating an initial hash in response to a first event on a vehicle network, the initial hash designated as a current hash; and
recursively generating a next hash based on a time associated with a next event on the vehicle network and based on the current hash, the next event occurring after the first event, the next hash being designated as the current hash for a next recursion of generating the next hash.
